(19) United States
(12) Patent Application Publication
(10) Pub. No.: US 2026/0167080 A1
(43) Pub. Date: Jun. 18, 2026

(54) VEHICLE MODULAR SUPPORT ASSEMBLY

(71) Applicant: Bambeds LLC, Sacramento, CA (US)

(72) Inventor: Ben Krumholz, Lompoc, CA (US)

(21) Appl. No.: 18/981,163

(22) Filed: Dec. 13, 2024

(51) Int. Cl. B60N 3/00

(52) U.S. Cl. CPC B60N 3/008

(57) ABSTRACT

An apparatus includes a support board including rectangular slots and connectors. Each connector includes a T-shaped end having a horizontal portion and a vertical portion and a connector base having a pair of connector legs between which a slot is defined. The vertical portion is positioned between the connector base and the horizontal portion and a space is defined between the connector base and the horizontal portion on either side of the vertical portion. The horizontal portion of each of the connectors is received in one of the rectangular slots and rotated about 90°to couple the connector to the support board and position an adjacent portion of the support board within the space defined by the corresponding connector. A leg received in the slot of one of the connector bases to secure the leg relative to the support board.

### FIELD

The disclosure relates to an adjustable support assembly for a vehicle and more particularly to a modular adjustable bed support platform for a truck or sport utility vehicle.

### BACKGROUND

Pickup trucks, sport utility vehicles (SUV), and wagon-type automobiles are versatile, popular vehicles. Such vehicles generally have a fairly large utility space that may be used for seating (in the case of SUV and wagon-type automobiles), and/or for hauling cargo. In some cases, the utility space may be used for temporary housing, such as with camper toppers for pickup truck beds. More minimalist adventurers may even use the vehicles for camping by rolling out sleeping bags or temporary mattresses in the utility space. However, when using the utility space for sleep, much of the space is left unusable.

### SUMMARY

Disclosed herein is an adjustable modular support assembly. The adjustable modular support assembly has a first platform having a first substantially planar body having a first support surface, first and second opposed side edges, first and second opposed end edges, and four corners. Each of the four corners being disposed between one side edge and one end edge. The first platform also includes a slot disposed in the substantially planar body and a shelf disposed along at least a portion of the first side edge of the first platform. The adjustable modular support assembly also includes a second platform having a second substantially planar body having a second support surface, first and second opposed side edges, first and second opposed end edges, and four corners. Each of the four corners being disposed between one side edge and one end edge. The second platform also includes a shoulder disposed along at least a portion of the second side edge of the second platform. The shoulder is configured to engage the shelf such that the first and second support surfaces are substantially coplanar. The adjustable modular support assembly also includes a vertical leg, including a first tab and a first notch disposed on the first tab. The first tab is selectively disposed within the slot of the first platform. The adjustable modular support assembly also includes a connector, including a second tab selectively disposed within the slot of the first platform and including a second notch that engages the first notch when the vertical leg and the connector are disposed in the slot of the first platform.

In some variations, the slot includes a twist-lock slot. For example, the twist-lock slot can include a first slot disposed substantially parallel with at least one of the first and second side edges of the first platform and a second slot disposed substantially parallel with at least one of the first and second end edges of the first platform, the second slot at least partially intersecting the first slot. Furthermore, the twist-lock slot can include a contra-leaf twisting aperture.

In other variations, the first notch and the second notch include complementary forked members. For example, the first notch can be upwardly oriented towards the first platform when the first tab is disposed in the slot and the second notch can be downwardly oriented away from the first platform when the second tab is disposed in the slot. Additionally, the second platform may not include a slot.

In yet other variations, the leg defines a plane disposed substantially parallel with at least a portion of at least one of the first and second side edges.

In some other variations, at least one of the shelf and the shoulder includes a pair of bumpers disposed on opposing ends of the shelf or shoulder and configured to engage the other one of the shelf and the shoulder to inhibit relative movement of the first and second platforms along a lengthwise direction.

In further variations, the adjustable modular support assembly includes a third platform. The third platform can include a third substantially planar body having a third support surface, first and second opposed side edges, first and second opposed end edges, and four corners. In some examples, each of the four corners can be disposed between one side edge and one end edge. In some examples, the third support surface is substantially coplanar with the first support surface and the second support surface. In some such examples, the second platform is disposed between the first and third platforms.

In yet further variations, the third platform includes a slot and a shelf disposed along a lengthwise direction of the third platform. Accordingly, the third platform can include a second vertical leg, including a first tab and a first notch disposed on the first tab of the second vertical leg, the first tab of the second vertical leg being selectively disposed within the slot of the third platform. The third platform can also include a second connector, including a second tab of the second connector selectively disposed within the slot of the third platform and including a second notch of the second connector that engages the first notch of the second vertical leg when the second vertical leg and the second connector are disposed in the slot of the third platform.

In other variations, the vertical leg and the second vertical leg are substantially parallel.

Further, in some variations, at least a portion of the second side edge of the first platform is configured to engage a wall of a truck bed.

Also disclosed herein is another adjustable modular support assembly. The adjustable modular support assembly includes a platform having a first substantially planar body having a first support surface, first and second opposed side edges defining a length, first and second opposed end edges defining a width, and four corners. Each of the four corners are disposed between one side edge and one end edge. The adjustable modular support assembly can also include a twist-lock slot asymmetrically disposed along the width of the platform. The adjustable modular support assembly also includes a vertical leg including a first tab and a first notch disposed on the first tab. The first tab is selectively disposed within the slot of the first platform. The adjustable modular support assembly can also include a connector, having a second tab selectively disposed within the slot of the first platform and including a second notch that engages the first notch when the vertical leg and the connector are disposed in the slot of the first platform.

In some variations, the twist-lock slot includes a first slot disposed in a lengthwise direction and a second slot disposed in a widthwise direction. The second slot at least partially intersects the first slot. Additionally, the twist-lock slot additionally includes a contra-leaf twisting aperture.

In some variations, the first notch and the second notch include complementary forked members. In some such examples, the first notch is upwardly oriented towards the platform and the second notch is downwardly oriented away from the platform. Additionally, the leg can define a plane oriented in a lengthwise direction of the first platform when the first tab is disposed in the twist-lock slot and the connector defines a plane oriented in a widthwise direction of the first platform when the second tab is disposed in the twist-lock slot.

In other variations, at least a portion of the second side edge of the first platform is configured to engage a wall of a truck bed.

Also disclosed herein is another adjustable modular support assembly. The adjustable modular support assembly includes a pair of platforms spaced apart from each other. Each platform includes a substantially planar body having a support surface, first and second opposed side edges and first and second opposed end edges. Additionally, the adjustable modular support assembly includes a slot disposed in the substantially planar body. The adjustable modular support assembly also includes a plurality of legs, each leg including a first tab and a first notch disposed on the first tab, the first tab being selectively disposed within a corresponding slot of the pair of platforms. The adjustable modular support assembly also includes a plurality of connectors. Each connector includes a second tab selectively disposed within a corresponding slot of the pair of platforms and including a second notch that engages the first notch when one of the plurality of legs and one of the plurality of connectors is disposed in the slot of the first platform.

In some variations, the adjustable modular support assembly includes a footer platform. The footer platform includes a support surface, first and second opposed side edges and first and second opposed end edges. In some examples, the footer platform includes a shoulder disposed on the first side edge of the footer platform. In such an example, each of the pair of platforms include a shelf disposed on the second end edge of each of the pair of platforms. The shelf is configured to engage the shoulder of the footer platform. Further, the footer platform can further include a slot and at least one leg and at least one connector on the footer.

In yet other variations, at least one of the shelf and the shoulder includes a pair of bumpers disposed on opposing ends of the shelf or shoulder and configured to engage the other one of the shelf and the shoulder to inhibit relative movement of the first and second platforms along a lengthwise direction.

In yet further variations, the adjustable modular support assembly can include a middle platform, disposed between the pair of platforms. The middle platform can include a support surface, first and second opposed side edges and first and second opposed end edges, and a shoulder disposed on the first side edge of the middle platform. In such examples, at least one of the pair of platforms includes a shelf disposed on the first side edge configured to engage the shoulder of the middle platform. In some such examples, the middle platform does not include a slot.

### BRIEF DESCRIPTION OF DRAWINGS

FIG. 1 is an isometric view of an example modular support assembly in accordance with the teachings of this disclosure.

FIG. 2 is a detailed plan view of the rectangular slot and the connector of the support board of the support assembly of FIG. 1.

FIG. 3 is an isometric view of one of the connectors of the support assembly of FIG. 1.

FIG. 4 is an isometric view of one of the legs of the support assembly of FIG. 1.

FIG. 5 is a detailed view of the second support board, the connector, and the leg of the support assembly of FIG. 1.

FIG. 6 is an upward facing exterior isometric view of the support assembly of FIG. 1.

FIG. 7 is an upward facing interior isometric view of the support assembly of FIG. 1.

FIG. 8 is an isometric view of another support assembly in accordance with the teachings of this disclosure.

FIG. 9 is an upward facing isometric view of the support assembly of FIG. 8.

FIG. 10 is a perspective view of an adjustable modular support assembly made in accordance with the present disclosure.

FIG. 11 is a perspective view a first platform of the adjustable modular support assembly of FIG. 10.

FIG. 12 is an enlarged view of an example slot disposed in the first platform of FIG. 11.

FIG. 13 is a perspective view a second platform of the adjustable modular support assembly of FIG. 10.

FIG. 14 is a perspective view a third platform of the adjustable modular support assembly of FIG. 10.

FIG. 15 is a perspective view of a fourth platform of the adjustable modular support assembly of FIG. 10.

FIG. 16 is a perspective view of an example leg of the adjustable modular support assembly of FIG. 10.

FIG. 17 is a perspective view of an example connector of the adjustable modular support assembly of FIG. 10.

FIG. 18 is a perspective view of another second adjustable modular support assembly made in accordance with the present disclosure.

FIG. 19 is a plan view of a first platform of the adjustable modular support assembly of FIG. 18.

FIG. 20 is an enlarged perspective view of a shelf disposed in the first platform of FIG. 19.

FIG. 21 is a perspective view of a second platform of the adjustable modular support assembly of FIG. 18.

FIG. 22 is an enlarged perspective view of a shoulder disposed on the second platform of FIG. 21.

FIG. 23 is a perspective view of a leg for use with the second adjustable modular support assembly of FIG. 18.

### DETAILED DESCRIPTION

Drivers are always looking to make better uses of vehicles. This is especially true for lovers of the outdoors. Often, outdoor lovers will use the vehicle as a mobile home. The clearest example of this is the recreational vehicle (RV) industry. RVs are essentially homes on wheels and can include every modern convenience of a stationary home. However, RVs can be large, cumbersome, and fuel inefficient, not to mention being very expensive to purchase. To minimize some of the drawbacks of full size RVs, some drivers attempt to convert utility vehicles, such as pickup trucks, vans, and sport utility vehicles (SUVs) into campers or temporary shelters. Such conversions can range from adding truck bed camper tops (complete with full beds and cooking facilities), to more minimalist approaches where a user simply rolls out a sleeping bag in the truck bed or utility area of a SUV or van.

In all cases, the utility space of the vehicle is not efficiently used, especially in the most minimalist of conversions where sleeping bags are rolled out in the truck bed or utility area. Essentially, the truck bed or utility area can either function as a bed (with a sleeping bag) or as a utility space to store and haul items, but not both. These choices generally lead to inefficient use of space. What is needed is a flexible storage system that makes better use of the available space in a truck bed or a utility space of a vehicle.

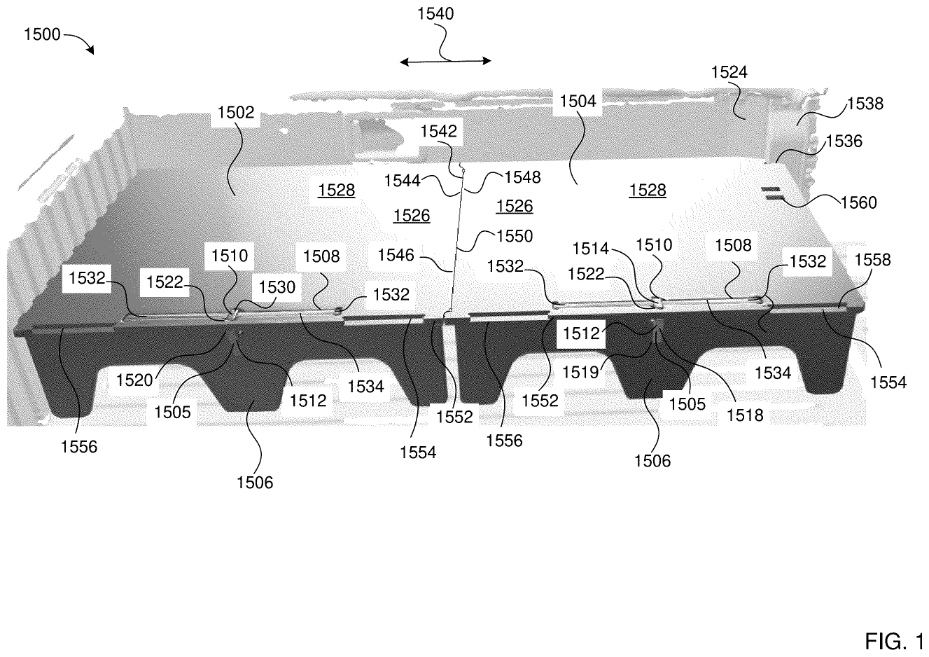

FIG. 1 is an isometric view of an example modular support assembly 1500 in accordance with the teachings of this disclosure. The support assembly 1500 includes a pair of support boards 1502, 1504, a plurality of connectors 1505, and a plurality of legs 1506. Each support board 1502, 1504 has a rectangular slot 1508. Each of the connectors 1505 has a T-shaped end 1510 and a connector base 1512 in the implementation shown.

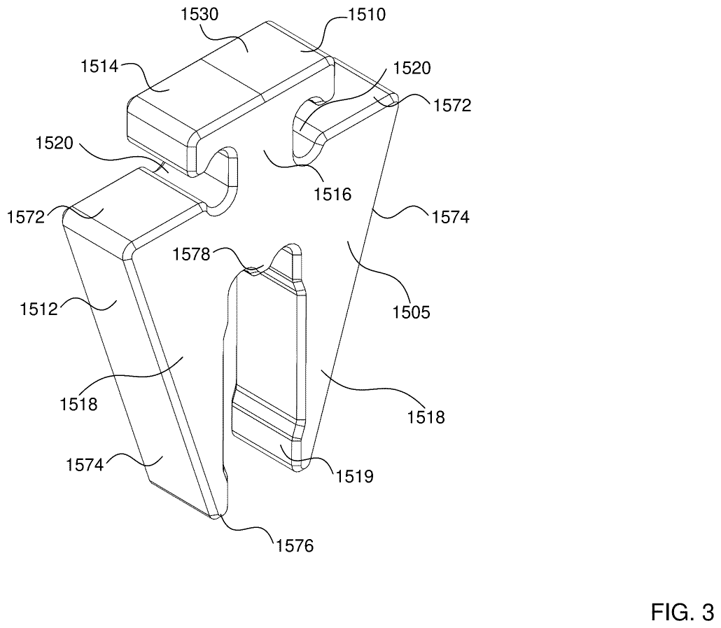

The T-shaped end 1510 has a horizontal portion 1514 and a vertical portion 1516 (more clearly shown in FIG. 3). The connector base 1512 has a pair of connector legs 1518 between which a slot 1519 is defined. The vertical portion 1516 is positioned between the connector base 1512 and the horizontal portion 1514. A space 1520 (more clearly shown in FIG. 3) is defined between the connector base 1512 and the horizontal portion 1514 on either side of the vertical portion 1516.

The horizontal portion 1514 of each of the connectors 1505 is shown received in one of the rectangular slots 1508 and rotated about 90° to couple the connector 1505 to the support board 1502, 1504 and position an adjacent portion 1522 of the support board 1502, 1504 within the space 1520 defined by the corresponding connector 1505. The connector 1505 may be coupled to the support board 1502, 1504 by an interference fit.

Each of the legs 1506 is shown received in the slot 1519 of one of the connector bases 1512 to secure the leg 1506 relative to the support board 1502, 1504. The support boards 1502, 1504 are shown abutting one another when installed in a vehicle 1524 to form a platform 1526.

Each support board 1502, 1504 has a top surface 1528 and each of the connectors 1505 has a connector top surface 1530 that is substantially flush with the top surface 1528 of the support board 1502, 1504.

Each of the legs 1506 has a pair of tongues 1532 in the implementation shown. The pair of tongues 1532 for each of the legs 1506 is received in a corresponding rectangular slot 1508 of the support board 1502, 1504. Each connector 1505 is shown positioned between a pair of tongues 1532 when the connector 1505 is coupled to the support board 1502, 1504 and the leg 1506 is secured relative to the support board 1502, 1504. The interaction between the tongues 1532, the connectors 1505, and the support boards 1502, 1504 may reduce relative movement between the legs 1506, the connectors 1505, and the support boards 1502, 1504. The tongues 1532 have a top surface 1534 that is shown substantially flush with the top surface 1528 of the support board 1502, 1504.

The support board 1504 defines a cutout 1536 to receive a vehicle tailgate bulkhead 1538. The interaction between the support board 1504 and the vehicle tailgate bulkhead 1538 may secure the support boards 1502, 1504 within the vehicle 1524 and/or deter movement of the support boards 1502, 1504 in a direction generally indicated by arrow 1540.

The support boards 1502, 1504 form an abutment joint 1542 when installed in the vehicle 1524 to form the platform 1526 in the implementation shown. The first support board 1502 has an end 1544 that has a protrusion 1546 and the second support board 1504 has an end 1548 having a cutout 1550 that receives the protrusion 1546 to form the abutment joint 1542.

Each of the support boards 1502, 1504 includes a longitudinal edge 1552 that in shown including a first step-shaped cutout 1554 and a second step-shaped cutout 1556. Additional support boards may be positioned within the vehicle 152 to abut the support boards 1502, 1504 and form a lap joint with the step-shaped cutouts 1554, 1556. The additional support boards may not include additional legs and, thus, the additional support boards may be supported by the legs 1506 of the support boards 1502, 1504 based on coupling of the lap joint. The support boards 1502, 1504 may include more cut outs or less of the step-shaped cutouts than shown.

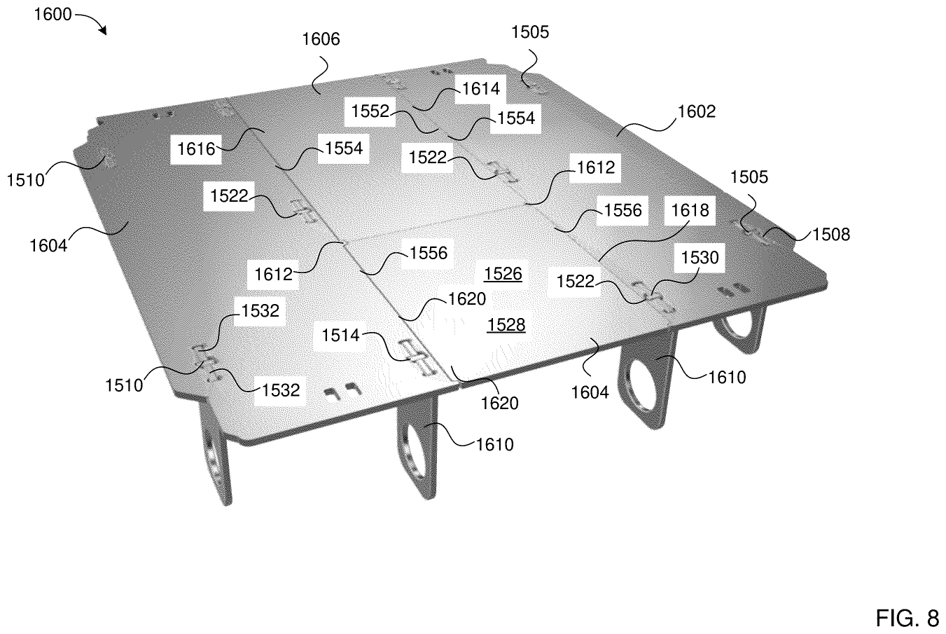

The rectangular slot 1508 is shown in FIG. 1 positioned between the first step-shaped cutout 1554 and the second step-shaped cutout 1556. The rectangular slots 1508 and/or the step-shaped cutouts 1554, 1556 may be in different positions, however. For example, the rectangular slots 1508 may be positioned along the step-shaped cutouts 1554, 1556 as shown in FIG. 8. The step-shaped cutouts 1554, 1556 may be a rabbit of a lap joint. The first step-shaped cutout 1554 and the second step-shaped cutout are shown as keyed step-shaped cutouts 1558.

The support board 1504 includes a hand hole 1560 in the implementation shown. The hand hole 1560 may be used by a user when installing and/or removing the support boards 1502 and/or 1504 from the vehicle 1524.

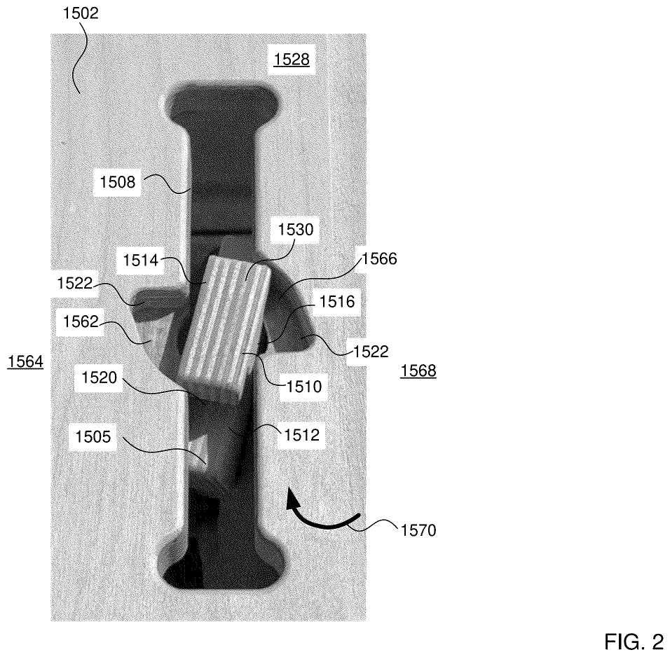

FIG. 2 is a detailed plan view of the rectangular slot 1508 and the connector 1505 of the support board 1502 of the support assembly 1500 of FIG. 1. The support board 1502 includes a first clearance slot 1562 on a first side 1564 of the rectangular slots 1508 and a second clearance slot 1566 on a second side 1568 of the rectangular slot 1508. The horizontal portion 1514 of the connector 1505 is to be received in the first clearance slot 1562 and second clearance slot 1566 when the connector 1505 is rotated about 90° in a direction generally indicated by arrow 1570 to position the adjacent portion 1522 of the support board 1502 within the space 1520 defined by the corresponding connector 1505. The first clearance slot 1562 and the second clearance slot 1566 are positioned at a 180-degree of rotation relative to each other. The clearance slots 1562, 1566 may be differently configured that shown.

FIG. 3 is an isometric view of the one of the connectors 1505 of the support assembly of FIG. 1. The connector 1505 has the T-shaped end 1510 and the connector base 1512. The connector base 1512 is shown including top surfaces 1572 and the side surface 1574that extend outwardly from the vertical portion 1516 of the T-shaped end 1510 and side surfaces 1574. Each side surface 1574 inwardly tapers from one of the top surfaces 1572 of the connector base 1512 toward an entrance 1576 of the slot 1519 of the connector base 1512. The connector base 1512 has a central protrusion 1578 that extends into the slot 1519 of the connector base 1512. The central protrusion 1578 locates the connector 1505 relative to the leg 1506 in some examples when the leg 1506 is received in the slot 1519 of the connector base 1512 to secure the leg relative to the support board 1502, 1504. The protrusion 1578 may be inwardly tapered as shown to allow the protrusion 15788 to self-locate the leg 1506 relative to the connector 1505, for example.

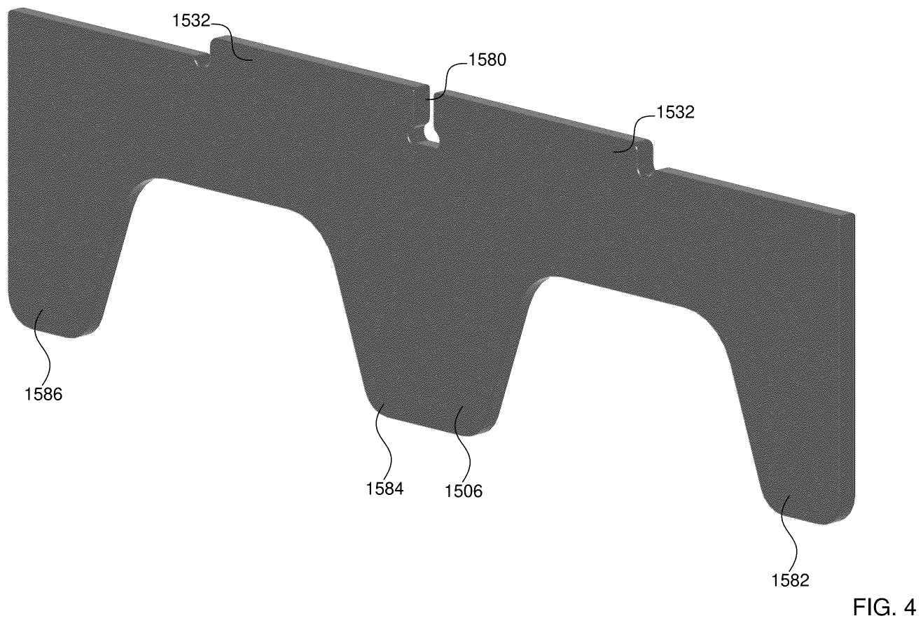

FIG. 4 is an isometric view of one of the legs 1506 of the support assembly 1500 of FIG. 1. The leg 1506 has a receptacle 1580 to receive the central protrusion 1578 of the connector 1505. The leg 1506 has the tongues 1532 and the receptacle 1580 is shown positioned between the tongues 1532. The leg 1506 has a plurality legs 1582, 1584, 1586 in some examples. The legs 1582, 1584, 1586 may be referred to as supports. The plurality of legs 1582, 1584, 1586 form an M-shape as shown. The leg 1506 may alternatively include one of the legs 1582, 1584, 1586, two of the legs 1582, 1584, 1586, etc.

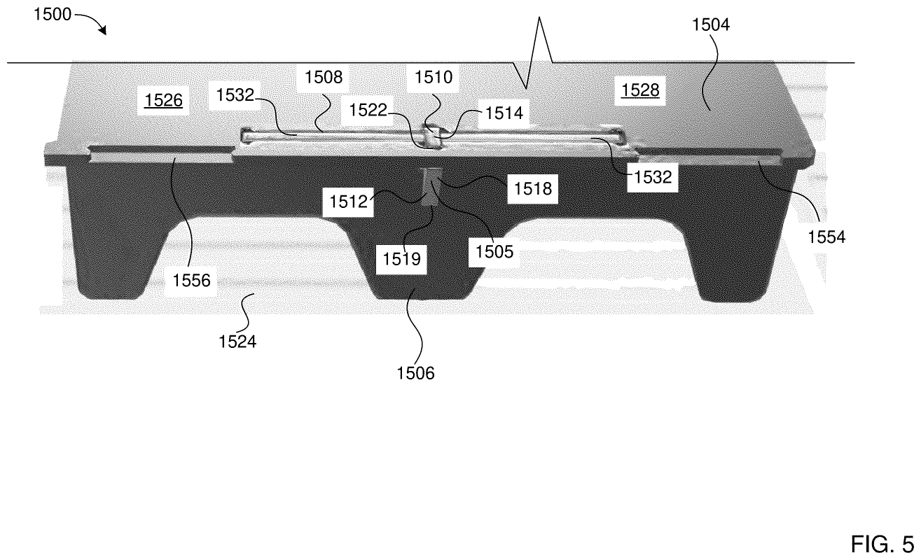

FIG. 5 is a detailed view of the second support board 1504, the connector 1505, and the leg 1506 of the support assembly 1500 of FIG. 1.

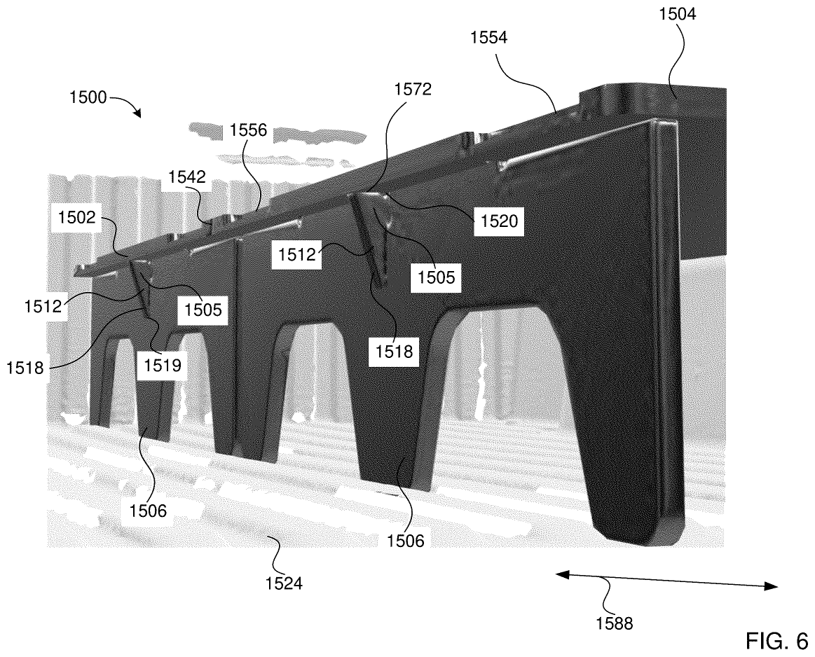

FIG. 6 is an upward facing exterior isometric view of the support assembly 1500 of FIG. 1. The top surfaces 1572 of the connectors 1505 are shown supporting the support boards 1502, 1504. An interaction between the top surfaces 1572 of the connector 1505 and a lower surface of the support boards 1502, 1504 may provide lateral support to the support assembly 1500 in a direction generally indicated by arrow 1588. For example, the interaction between the top surfaces 1572 of the connector 1505 and the support boards 1502, 1504 may provide increased support to the coupling between the legs 1506 and the support boards 1502, 1504.

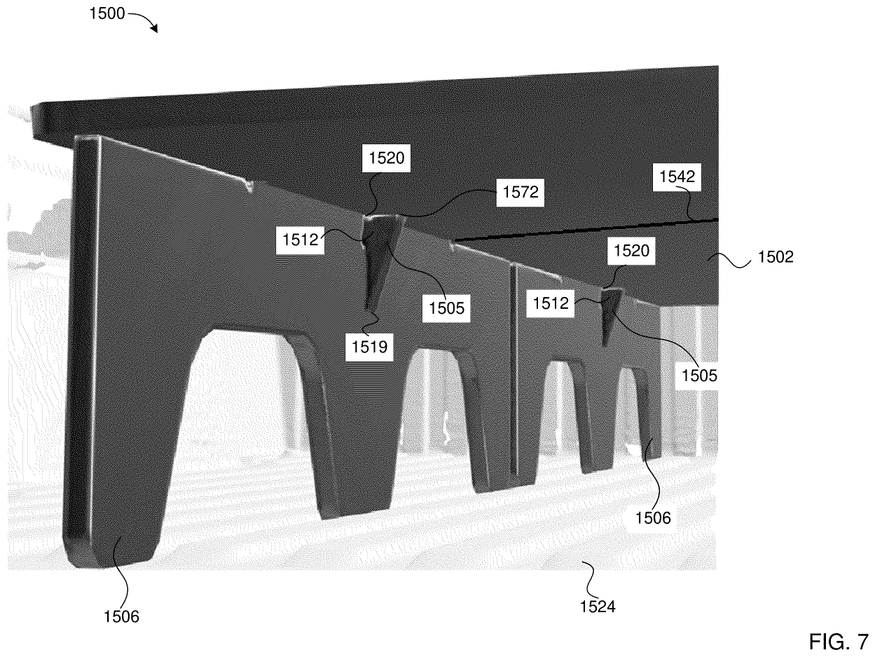

FIG. 7 is an upward facing interior isometric view of the support assembly 1500 of FIG. 1. The top surfaces 1572 of the connectors 1505 are shown supporting the support boards 1502, 1504.

FIG. 8 is an isometric view of another support assembly 1600 in accordance with the teachings of this disclosure. The support assembly 1600 of FIG. 8 is similar to the support assembly 1500 of FIG. 1. The support assembly 1600 of FIG. 8 includes a first support board 1602, a second support board 1604, a first central support board 1606, and a second central support board 1608. The first and second support boards 1602, 1604 include a plurality of the rectangular slots 1508. The first and second central support boards 1606, 1608 are positioned between the first support board 1602 and the second support board 1604. The support assembly 1600 include connectors 1505 and legs 1610.

The first and second support boards 1602, 1604 each have a longitudinal edge 1552 that has a first step-shaped cutout 1554 and a second step-shaped cutout 1556 and a spacer 1612 positioned between the first step-shaped cutout 1554 and the second step-shaped cutout 1556. The spacer 1612 may be referred to as a bumper.

A first lap joint 1614 is formed between the first central support board 1606 and the first support board 1602 and a second lap joint 1616 is formed between the first central support board 1606 and the second support board 1604. Similarly, a first lap joint 1618 is formed between the second central support board 1608 and the first support board 1602 and a second lap joint 1620 is formed between the second central support board 1608 and the second support board 1604.

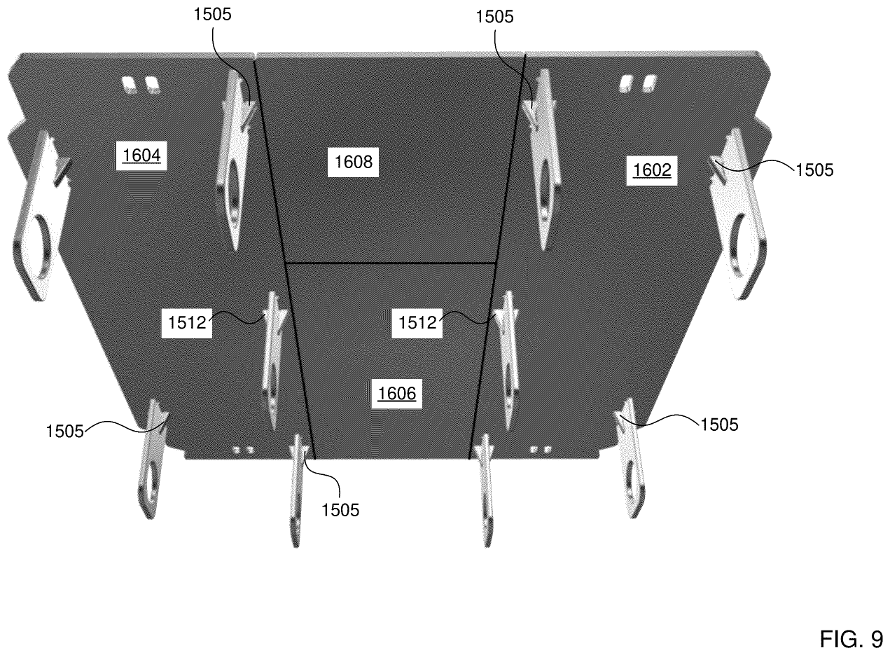

FIG. 9 is an upward facing isometric view of the support assembly 1600 of FIG. 8.

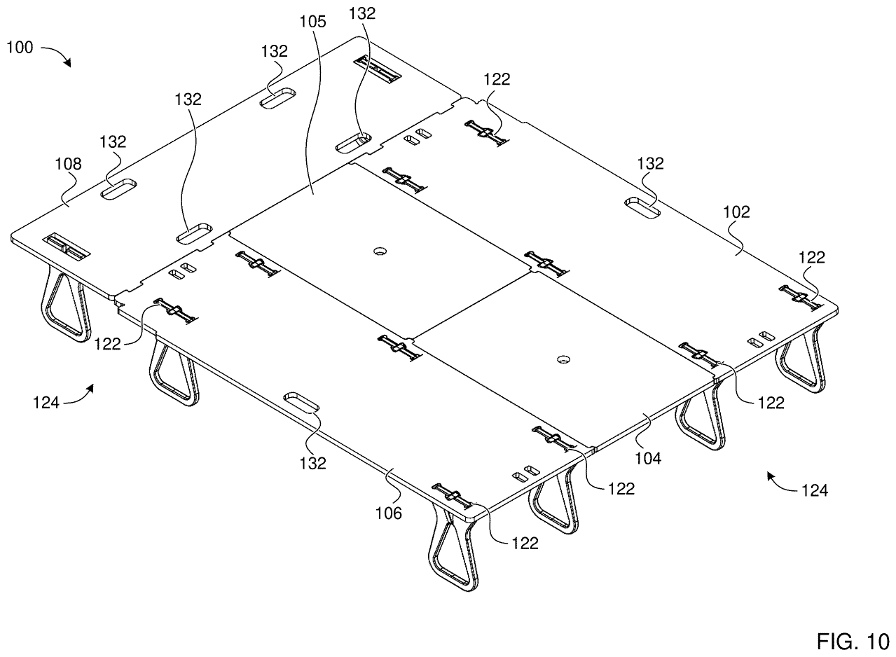

FIG. 10 illustrates a first example adjustable modular support assembly 100 including a first platform 102, a second platform 104 (sometimes referred to as a middle platform), a third platform 106, and a fourth platform 108 (sometimes referred to as a footer platform). The adjustable modular support assembly 100 is similar to the support assembly 1600 of FIG. 8. In the present example, the adjustable modular support assembly 100 includes an additional second platform 105, but in other examples, the two second platforms 104, 105 are a single, monolithic platform. As shown in FIG. 10, the first, second, third, and fourth platforms 102, 104, 105, 106, 108 are substantially coplanar. As used herein, substantially coplanar means between about 0°-10° of coplanar including coplanar itself. However, in various examples, coplanar can include adjacent platforms that are up to 30° relative to one another.

As shown in FIG. 10, the first and third platforms 102, 106 are disposed opposite each other and the second platforms 104, 105 are disposed between the first and third platforms 102, 106. In some examples, the first, second, and third platforms 102, 104, 105, 106 fill or substantially fill the area of a truck bed. In such an example, at least a portion of the first and third platforms 102 ,106 is configured to engage a wall of a truck bed. Additionally, in some examples, the fourth platform 108 can be disposed in a truck bed adjacent a cab of the truck or can be placed on the tailgate when the tailgate of the truck bed is lowered. As a result, the adjustable modular support assembly 100 can be configured to fully cover the truck bed.

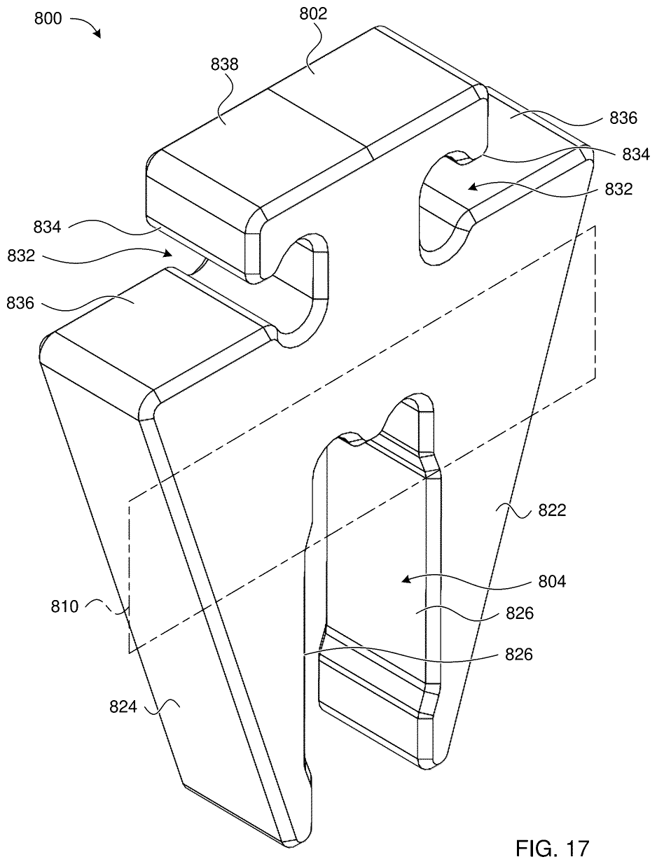

As shown in FIG. 10, the adjustable modular support assembly 100 includes a plurality slots 122, a plurality of vertical legs 124, and a plurality of connectors (shown in FIG. 17). In the present example, there is an equal number of slots 122, vertical legs 124, and connectors. The vertical legs 124 are secured in the slots 122 via the connectors (as will be described in greater detail below). In the present example, the vertical legs 124 are all substantially parallel to each other and uniformly elevate the first, second, third, and fourth platforms 102, 104, 105, 106, and 108 relative to a truck bed. As used herein, substantially parallel means between about 0°-10° of parallel including parallel itself. As used herein, substantially perpendicular means between about 0°-10° of perpendicular including perpendicular itself. In the present example, each of the plurality of vertical legs 124 is identical, but in other examples, a subset or each of the vertical legs 124 can be different.

Also shown in FIG. 10, the first, third, and fourth platforms 102, 106, and 108 also include handholds 132. The handholds 132 are sized and positioned on the first, third, and fourth platforms 102, 106, and 108 for convenient handling by most persons. In some examples, the second platforms 104, 105 also include handholds 132. In various examples, the handholds 132 help facilitate the assembly of the adjustable modular support assembly 100.

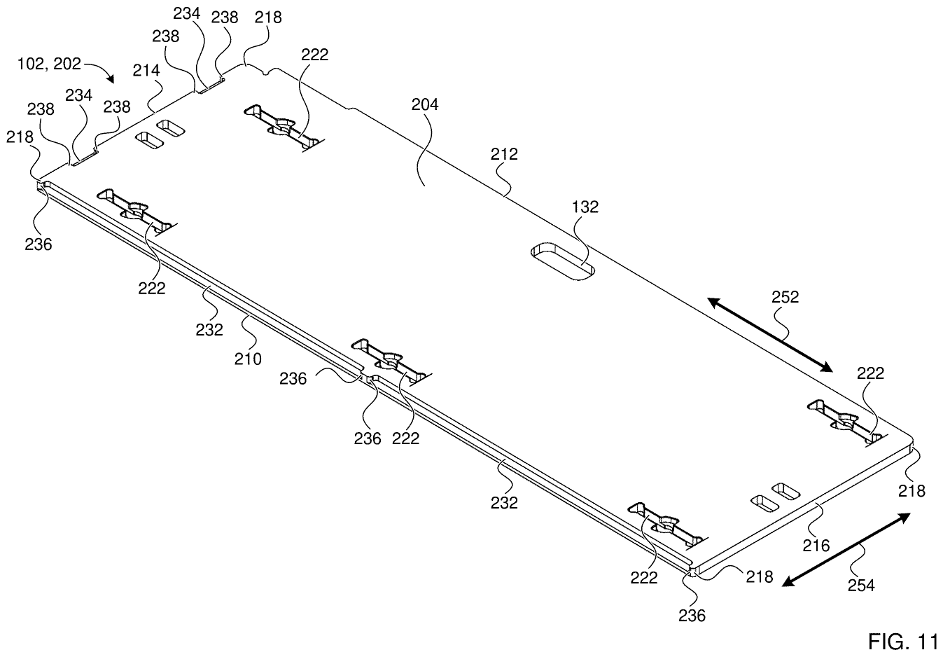

FIG. 11 illustrates, in greater detail, the first platform 102. The first platform 102 is a first substantially planar body 202 having a first support surface 204. The first substantially planar body 202 is defined by first and second opposed side edges 210, 212 (defining a length) and first and second opposed end edges 214, 216 (defining a width) and four corners 218, each of the four corners 218 being disposed between one side edge 210, 212 and one end edge 214, 216. In the present example, the first substantially planar body 202 is made of a material and defines a thickness sufficient to support heavy loads on the first platform 102. For example, the first platform 102 is configured to support hundreds of pounds (e.g., 200 lbs, 400 lbs, 600 lbs) over the surface area of the planar body 202.

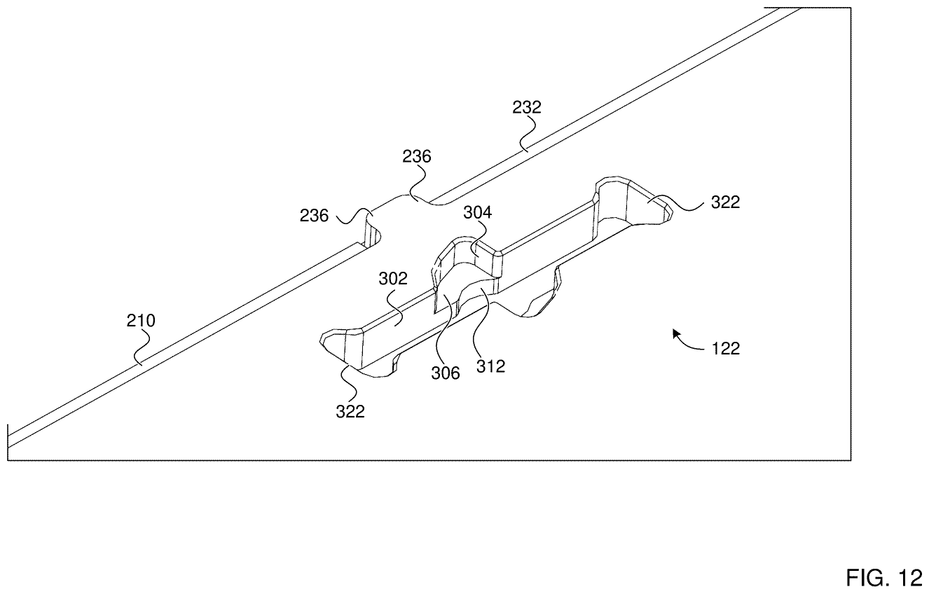

The first platform 102 further includes a slot 222 disposed in the substantially planar body 202. As shown in FIG. 11, the slot 222 passes through the thickness of the first substantially planar body 202. In the present example, the slot 222 is a twist-lock slot (described in greater detail in connection with FIG. 12) asymmetrically disposed along the width of the platform 102. As shown in FIG. 11, the slot 222 is disposed on the left side of the first platform 102.

The first platform 102 additionally includes a shelf 232 disposed along at least a portion of the first side edge 210. In the present example, the first platform 102 includes two shelves 232, but in other examples, the first platform 102 could include one or more than two shelves 232. As shown in FIG. 11, the shelf 232 may be approximately half the thickness of the first substantially planar body 202 and a depth of approximately 1 inch (in.). In various other examples, the shelf 232 could have a depth of approximately ¼ in., approximately ½ in., approximately 1.5 in., or approximately 2 in.

The first platform 102 additionally includes shelves 234 disposed along the first end edge 214. As shown in FIG. 11, the first end edge 214 includes two shelves 234, but could include one or more than two shelves 234. The shelf 232 may be approximately half the thickness of the first substantially planar body 202 and a depth of approximately 1 inch (in.). In various other examples, the shelf 232 could have a depth of approximately ¼ in., approximately ½ in., approximately 1.5 in., or approximately 2 in.

Additionally, as shown in FIG. 11, the shelves 232 include bumpers 236 and the shelves 234 include bumpers 238. The bumpers 238 may also be referred to as spacers. Each of the shelves 232 and the shelves 234 include bumpers 236, 238 disposed on opposing ends of the shelves 232, 234 respectively. In the present example, the bumpers 236, 238 are rounded to facilitate engagement and alignment of the bumpers 236, 238 to the other platforms (e.g., the second platform 104). In some examples, the bumpers 236, 238 can be partially hook shaped to secure the bumpers 236, 238 to the other platforms.

As will be discussed in greater detail below, shelves 232, 234 engage shoulders (discussed in greater detail below) disposed on, for example, the second or fourth platforms 104, 108. Additionally, the bumpers 236, 238 are configured to engage bumpers disposed on the shoulders. In accordance with the present disclosure, the engagement of the shelves 232, 234 and the shoulders inhibit relative movement of the first and second platforms 102, 104 along a lengthwise direction 252 and/or the first and fourth platforms 102, 108 along a widthwise direction 254.

FIG. 12 is an enlarged view of the slot 122 of the first platform 102. As shown in FIG. 12, the slot 122 is disposed adjacent the first side edge 210 and proximate to the bumpers 236. In various other examples, the slot 122 could be disposed closer to or further away from the first side edge 210. Additionally, the slot 122 passes through the substantially planar body 202, but in some examples, the slot 122 only passes partially through the substantially planar body 202.

In the present example, the slot 122 is a twist-lock slot. The twist-lock slot includes a first slot 302 disposed substantially parallel with at least one of the first and second side edges 210, 212 of the first platform 102. The slot 122 further includes a second slot 304 disposed substantially parallel with at least one of the first and second end edges 214, 216 of the first platform 102. The second slot 304 at least partially intersecting the first slot 302. the twist-lock slot additionally includes a contra-leaf twisting aperture 306. As will be discussed in greater detail below, a connector is inserted into the first slot 302 and rotated through the contra-leaf twisting aperture 306 and into the second slot 304.

The contra-leaf twisting aperture 306 includes a rib 312. The rib 312 may be approximately half the thickness of the first platform 102. In the present example, the connector (discussed in greater detail below in connection with FIG. 17) is configured to engage the rib 312 to secure the connector to the first platform 102. Additionally, in some examples, the second slot 304 is sized to hold the connector (as described below in greater detail).

Additionally, as shown in FIG. 12, the first slot 302 can include reliefs 322. The reliefs 322 are wider than the first slot 302. In some examples, the reliefs 322 are configured to facilitate insertion of the vertical legs 124 into the first slots 302. In other examples, the reliefs 322 facilitate the cutting of the first slot 302 into the first platform 102.

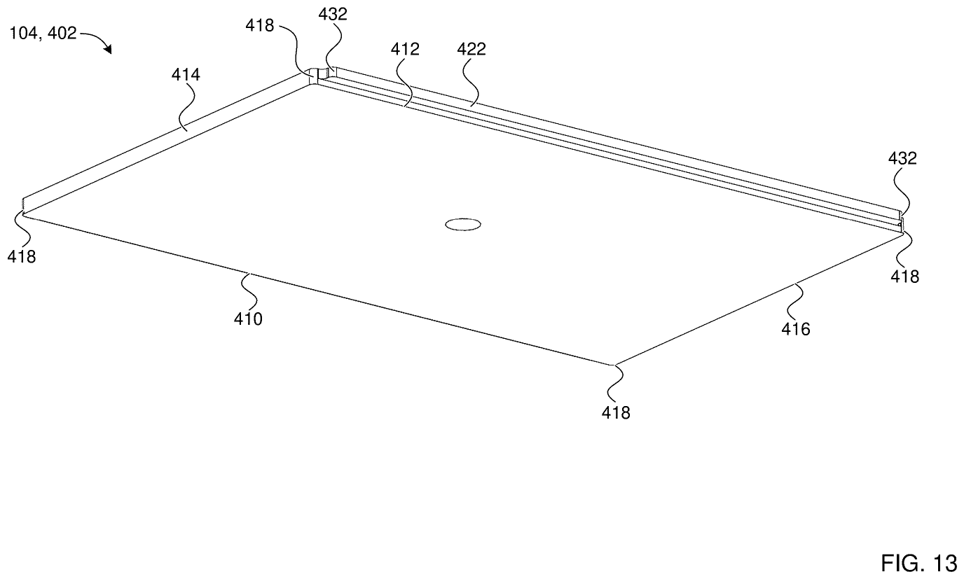

FIG. 13 illustrates, in greater detail, the second platform 104 of FIG. 10. The second platform includes a second substantially planar body 402 having a second support surface (not shown in FIG. 13), first and second opposed side edges 410, 412; first and second opposed end edges 414, 416; and four corners 418. Each of the four corners 418 being disposed between one side edge 410, 412 and one end edge 414, 416. In the present example, the second platform 105 is substantially identical to the second platform 104. In various other examples, the second platforms 104, 105 can be different.

As shown in FIG. 13, the second platform 104 includes a shoulder 422 disposed along at least a portion of the second side edge 412. The shoulder 422 is configured to engage the shelf (e.g., the shelf 232). In the present example, the shoulder 422 may be approximately half the thickness of the second substantially planar body 402. In some examples, the thickness of the shelf 232 and the shoulder 422 is equal to the thickness of the first and second platforms 102, 104. Additionally, the first and second platforms 102, 104 are configured to be substantially coplanar when the shoulder 422 engages the shelf 232.

In the present example, the shoulder 422 includes a pair of bumpers 432 disposed on opposing ends of the shoulder 422 and configured to engage the shelf 232 to inhibit relative movement of the first and second platforms 102, 104 along the lengthwise direction 252 (as shown in FIG. 11). For example, the bumpers 432 engage the bumpers 236 of the first platform 102 to limit or inhibit lengthwise movement of the first and second platforms 102, 104.

In some examples, the second platform 104 does not include a slot. For example, the second platform 104 is not configured to be supported by any vertical legs (e.g., vertical legs 124). As shown in FIG. 10, the second platform 104 engages the first and third platforms 102, 106 and does not need to be supported by any other support structure. Because the second platform 104 is not supported by any of the vertical legs 124, there is increased storage volume underneath the adjustable modular support assembly 100.

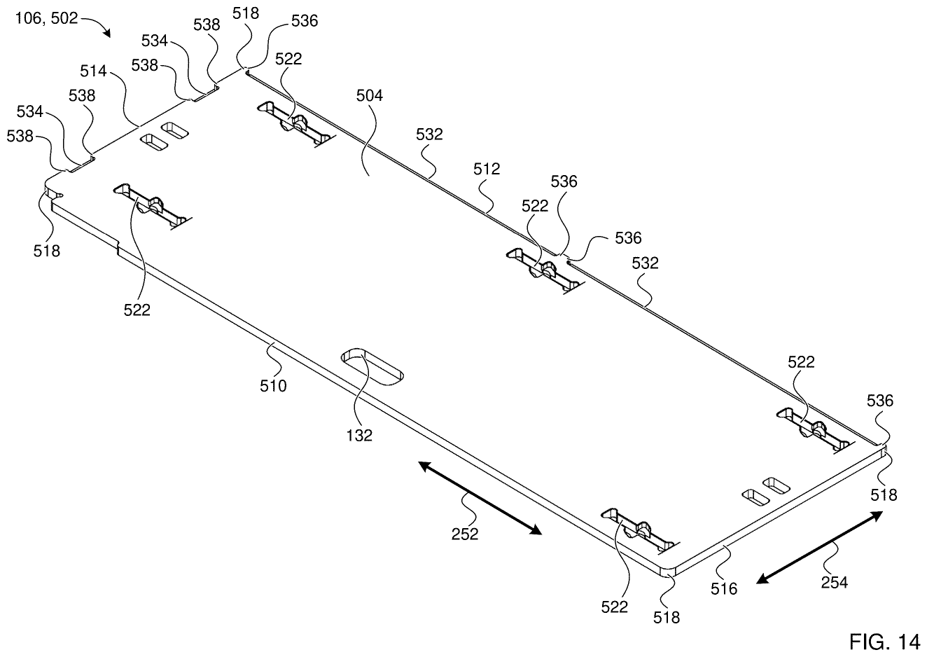

FIG. 14 illustrates the third platform 106 including a third substantially planar body 502 having a third support surface 504, first and second opposed side edges 510, 512, first and second opposed end edges 514, 516, and four corners 518. Each of the four corners 518 being disposed between one side edge 510, 512 and one end edge 514, 516. In the present example, the third platform 106 is similar to the first platform 102, but mirrored about the second platform 104.

The third platform 106 further includes a slot 522 disposed in the third substantially planar body 502. As shown in FIG. 14, the slot 522 passes through the thickness of the third substantially planar body 502. In the present example, the slot 522 is identical to the slot 222 of FIGS. 11 and 12.

Additionally, the third platform 106 additionally includes shelves 532 and bumpers 536, 538. In the present example, the third platform 106, including the shelves, 532 and bumpers 536, 538 is substantially identical to the shelf 232 as shown and described above in connection with FIG. 11.

Similar to the first platform 102, shelves 532 engage shoulders (e.g., shoulder 422) disposed on, for example, the second or fourth platforms 104, 108. Additionally, the bumpers 536, 538 are configured to engage bumpers disposed on the shoulders (e.g., bumpers 432). In accordance with the present disclosure, the engagement of the shelves 532, 534 and the shoulders inhibit relative movement of the second and third platforms 104, 106 along a lengthwise direction 252 and the third and fourth platforms 106, 108 along a widthwise direction 254.

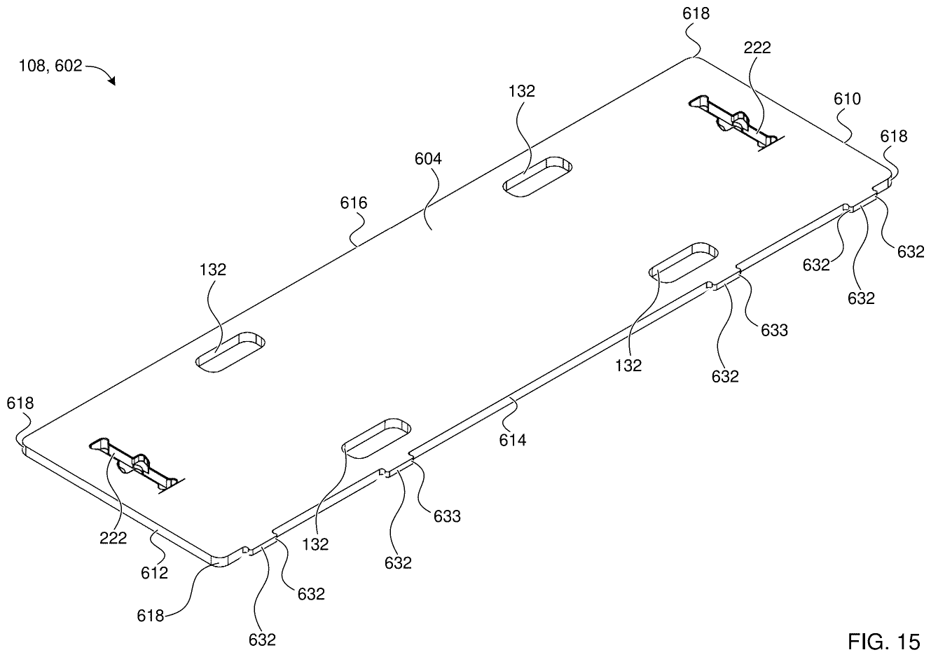

FIG. 15 illustrates the fourth platform 108 including a fourth substantially planar body 602 having a fourth support surface 604, first and second opposed side edges 610, 612, first and second opposed end edges 614, 616, and four corners 618. Each of the four corners 618 being disposed between one side edge 610, 612 and one end edge 614, 616.

The fourth platform 108 includes shoulders 632 disposed along at least a portion of the first end edge 614. The shoulders 632 are configured to engage the shelves 232, 532 of the first and third platforms 102, 106. In the present example, the shoulder 632 may be approximately half the thickness of the fourth substantially planar body 602. In some examples, the thicknesses of the shelves 232, 532 and the shoulders 632 are equal to the thickness of the first, third, and fourth platforms 102, 106, 108. Additionally, the fourth platform 108 is configured to be substantially coplanar with the first and third platforms 102, 106 when the shoulders 632 engages the shelves 232, 532.

Further, the shoulder 632 includes a pair of bumpers 633 disposed on opposing ends of each shoulder 632 and configured to engage the shelves 232, 532 to inhibit widthwise movement (e.g., along the widthwise direction 254) of the fourth platform 108 relative to the first and third platforms 102, 106. For example, the bumpers 633 engage the bumpers 236, 536 of the first and third platforms 102, 106 to limit widthwise movement of the fourth platform 108.

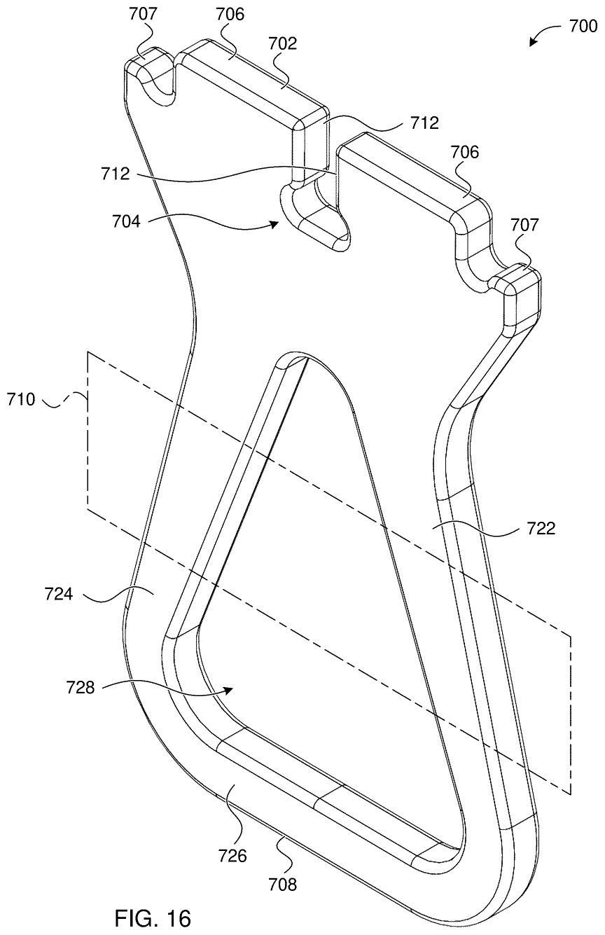

FIG. 16 illustrates a vertical leg 700. The leg 700 can be one of the vertical legs 124 of FIG. 10. As shown in FIG. 16, the vertical leg 124 including a first tab 702 and a first notch 704 disposed on the first tab 702. The first tab 702 is configured to be selectively disposed within a slot (e.g., slot 122) of the first, third, and fourth platforms 102, 106, 108. The notch 704 will be discussed in greater detail below, in connection with the connector 800 of FIG. 17. The first tab 702 may be referred to as a tongue or as including tongues.

The leg 700 includes a first top surface 706, disposed on the first tab 702, a second top surface 707, and a bottom surface 708 disposed opposite the first and second top surfaces 706, 707. The first top surface 706 is configured to be aligned and substantially coplanar with the first, third, or fourth support surfaces 204, 504, 604 when disposed in a corresponding slot 122 of the first, third, or fourth platforms 102, 106, 108. Additionally, the second top surface 706 are configured to engage an underside of the first, third, or fourth platforms 102, 106, 108 when the first tab 702 is disposed in the slot 122. Further, the bottom surface 708 is configured to engage a flat surface of a truck bed. In some examples, truck beds include a crenellated surface and the legs 124 are sized to engage the higher and/or lower levels of the truck bed to ensure the adjustable modular support assembly 100 is substantially level when assembled and placed in a truck bed.

In the present example, the leg 700 includes a first leg 722, a second leg 724, and a horizontal base 726 defining the bottom surface 708. In the present example, the horizontal base 726 engages the ground or a truck bed. As shown in FIG. 16, the first leg 722, the second leg 724, and the horizontal base 726 define a tear-drop shaped aperture 728. The aperture 728 reduces the amount of material used in manufacturing the leg 700. In other examples, the aperture 728 is differently shaped including, elliptical, obround, rectangular, triangular, etc. In other examples, the leg 700 includes a first leg 722 and a second leg 724, but they aren't connected by the horizontal base 726. In such an example, each of the first and second legs 722, 724 are configured to engage a floor or truck bed.

The leg 700 defines a plane 710 disposed substantially parallel with at least a portion of at least one of the first and second side edges 210, 212 of the first platform 102. Similarly, the plane 710 is also substantially parallel with at least a portion of the first and second side edges 410, 412 of the second platform 104, the first and second side edges 510, 512 of the third platform 106, and the first and second side edges 610, 612 of the fourth platform 108.

FIG. 17 illustrates a connector 800. The connector 800 includes a second tab 802 configured to be selectively disposed within the slot 222, 522, 622 of the first, third, and fourth platforms 102, 106, 108. In some examples, the second tab 802 is initially inserted into the first slot 302 and then rotated into the second slot 304 (as will be discussed in greater detail below). The connector also includes a second notch 804. The second notch 804 is configured to engage the first notch 704 when the vertical leg 700 and the connector 800 are disposed in the slot 122, 522, 622 of the first, third, and fourth platforms 102, 106, 108 (as shown in FIG. 10).

In the present example, the connector 800 defines a plane 810. When the second tab 802 is disposed in the slot 122, and specifically, the second slot 304, the plane 810 is substantially parallel with at least one of the end edges 214, 216, 514, 516, 614, 616 of the first, third, or fourth platforms 102, 106, 108. Accordingly, the plane 810 is perpendicular to the plane 710 when both the vertical leg 700 and the connector 800 are disposed in the slot 122. As will be discussed in greater detail below, the first notch 704 and the second notch 804 are interconnected when the planes 710, 810 are perpendicular and the tabs 702, 802.

The second notch 804 is defined by a first leg 822 and a second leg 824 disposed on both sides of the notch 804. Each of the first and second legs 822, 824 includes a locking surface 826. As shown in FIG. 17, the second notch 804, and the first and second legs 822, 824 are downwardly oriented, away from the first, third, and fourth platforms 102, 106, 108 when the second tab 802 is disposed in the slot 122. The locking surfaces 826 are inwardly directed towards each other. As shown in FIG. 17, the first and second legs 822, 824 are tapering and the connector 800 overall has a triangular shape. In various other examples, the connector 800 can be other shapes including rectangular, elliptical, round, etc.

The connector 800 further includes side notches 832. The side notches 832 are disposed underneath the second tab 802. The side notches 832 are sized to receive the rib 312 of the contra-leaf twisting aperture 306. As a result, the tab 802 can be first inserted into first slot 302 and twisted in the contra-leaf twisting aperture 306. Additionally, the side notches 832 are defined by a top locking surface 834 and a bottom locking surface 836. The top and bottom locking surfaces 834, 836 engage the rib 312 (shown in FIG. 12) and releasably secure the connector 800 in the second slot 304. The distance between the top locking surface 834 and the bottom locking surface 836 is approximately equal to the thickness of the rib 312, but in some examples, the distance could be slightly less than the thickness of the rib 312 to provide a press fit connection or the distance could be greater than the thickness of the rib 312 to increase the ease of twisting the connector 800 from the first slot 302 to the second slot 304.

As shown in FIG. 17, the tab 802 includes a top surface 838. In some examples, when the connector 800 is releasably secured in the second slot 304, the top surface 838 is substantially coplanar with the at least one of the first, third, and fourth platforms 102, 106, 108.

Assembling the first example adjustable support assembly 100 begins with connecting the connectors 800 and vertical legs 124, 700 to the first and third platforms 102, 106. For example, first, the connector 800 is first inserted into the slot 122. In some examples, the second tab 802 is inserted into the first slot 302 and twisted into the second slot 304. In some examples, when the connector 800 is twisted into the second slot 304, the rib 312 of the contra-leaf twisting aperture 306 is received within the side notches 832 of the connector 800. As a result, the connector 800 is selectively secured in the second slot 304 because the rib 312 is wedged between the top and bottom locking surfaces 834, 836.

With the connector 800 secured in the second slot 304, the leg 700 is configured to engage with the connector 800. Specifically, the first notch 704, being upwardly oriented, and the second notch 804, being downwardly oriented, engage and intersect each other. When the first and second notches 704, 804 engage each other, the planes 710, 810 are perpendicular to each other. Additionally, the locking surfaces 712 engage the connector 800 and the locking surfaces 826 engage the leg 700. The engagement of the locking surfaces 712, 826 to the connector 800 and leg 700, respectively, inhibits relative rotation between the leg 700 and the connector 800. For example, the first notch 704 and the second notch 804 comprise complementary forked members.

Furthermore, when the first and second notches 704, 804 engage each other, the first tab 702 of the leg 700 is disposed in the slot 122. Specifically, the first tab 702 is disposed in the first slot 302. When the first tab 702 is disposed in the first slot 302 and engaged with the connector 800, the leg 700 is unable to twist relative to any one of the first, third, and fourth platforms 102, 106, 108. Similarly, the connector 800 when disposed in the second slot 304 and engaging the leg 700, is unable to twist relative to any one of the first, third, and fourth platforms 102, 106, 108.

With the legs 700 and connectors 800 disposed in each of the slots 302, 304, of the first, third, and fourth platforms 102, 106, 108, the first, third, and fourth platforms 102, 106, 108 are disposed in the truck bed. First, the first and third platforms 102, 106 are inserted into a truck bed. The first and third platforms 102, 106 are configured to engage the right and left walls of the truck bed, respectively. For example, the second side edge 212 of the first platform 102 engages the right wall of the truck bed. However, in other examples, the second side edge of the first platform 102 could be configured to engage the left wall of the truck bed.

With at least the first and third platforms 102, 106 disposed in the truck bed and spaced apart from each other, the second platform 104 can be placed between the first and third platforms 102, 106. The shoulders 422 of the second platform 104 engage the shelves 232, 532 of the first and third platforms 102, 106, respectively. The second platform 104 is supported the first and third platforms 102, 106 and is not directly supported by any legs 124.

Additionally, in some examples, the fourth platform 108 is coupled to first and third platforms 102, 106. For example, the fourth platform 108 can be configured to be placed on a lowered tailgate of a truck bed. In other examples, the fourth platform 108 can be disposed in the truck bed closest to a truck cab.

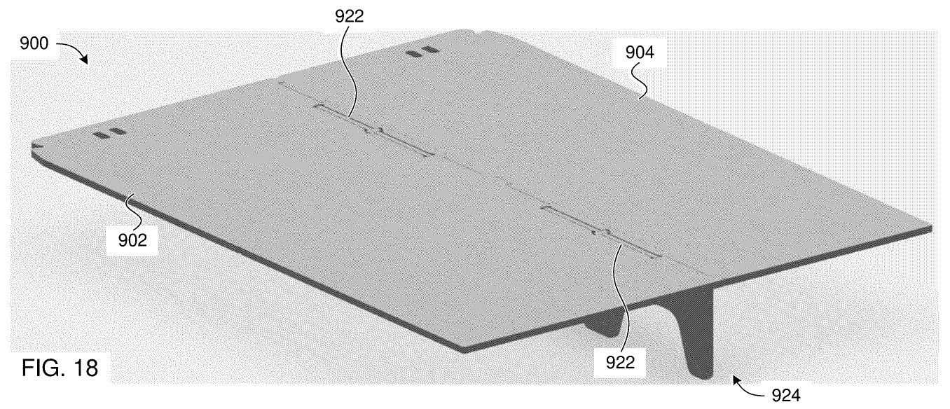

FIG. 18 illustrates a second example adjustable modular support assembly 900 including a first platform 902 and a second platform 904. The adjustable modular support assembly 800 may be implemented by the modular support assembly 1500 of FIG. 1. As will be described in greater detail below, the first platform 902 is similar to the first platform 102 of FIG. 10.

As shown in FIG. 18, the adjustable modular support assembly 900 includes a plurality slots 922, a plurality of vertical legs 924, and a plurality of connectors (e.g., the connector 800 of FIG. 17). In the present example, there is an equal number of slots 922, vertical legs 924, and connectors 800. The vertical legs 924 are secured in the slots 922 via the connectors (as discussed above in connection with FIGS. 16 and 17). In the present example, the vertical legs 924 are all aligned and uniformly elevate the first and second platforms 102, 104 relative to a truck bed. In the present example, each of the plurality of vertical legs 124 is identical, but in other examples, a subset or each of the vertical legs 124 can be different.

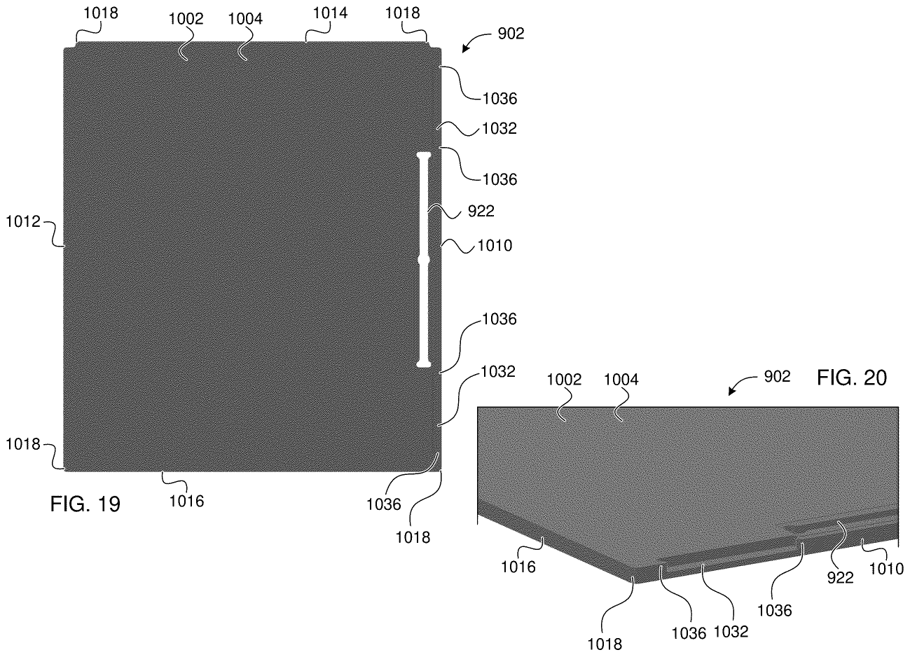

FIGS. 19 and 20 illustrate, in greater detail, the first platform 902. The first platform 902 is similar to the first platform 102 and includes a first substantially planar body 1002 having a first support surface 1004. The first substantially planar body 1002 is defined by first and second opposed side edges 1010, 1012 and first and second opposed end edges 1014, 1016 and four corners 1018, each of the four corners 1018 being disposed between one side edge 1010, 1012 and one end edge 1014, 1016. In the present example, the first substantially planar body 1002 is made of a material and defines a thickness sufficient to support heavy loads on the first platform 902. For example, the first platform 902 is configured to support hundreds of pounds (e.g., 200 lbs, 400 lbs, 600 lbs) over the surface area of the planar body 1002.

The first platform 902 further includes a slot 922 disposed in the substantially planar body 1002. The slot 922 is substantially identical to the slot 122 of FIGS. 10 and 12. In the present example, the slot 922 is longer than the slot 122, but still includes a first slot, second slot, and contra-leaf twisting aperture. As shown in FIGS. 18 and 19, the slot 922 is disposed on the right side of the first platform 902.

The first platform 902 additionally includes a shelf 1032 disposed along at least a portion of the first side edge 1010. In the present example, the first platform 902 includes two shelves 1032, but in other examples, the first platform 902 could include one or more than two shelves 1032. As shown in FIG. 19, the shelf 1032 may be approximately half the thickness of the first substantially planar body 1002 and a depth of approximately 1 inch (in.). In various other examples, the shelf 1032 could have a depth of approximately ¼ in., approximately ½ in., approximately 1.5 in., or approximately 2 in.

Additionally, as shown in FIG. 19, the shelves 1032 include bumpers 1036. Each of the shelves 1032 include bumpers 1036 disposed on opposing ends of the shelves 1032.

As will be discussed in greater detail below, shelves 1032, 1034 engage shoulders (discussed in greater detail below) disposed on, for example, the second or fourth platforms 104, 108. Additionally, the bumpers 1036, 1038 are configured to engage bumpers disposed on the shoulders. In accordance with the present disclosure, the engagement of the shelves 1032, 1034 and the shoulders inhibit relative movement of the first and second platforms 102, 104 along a lengthwise direction 1052 and the first and fourth platforms 102, 108 along a widthwise direction 1054.

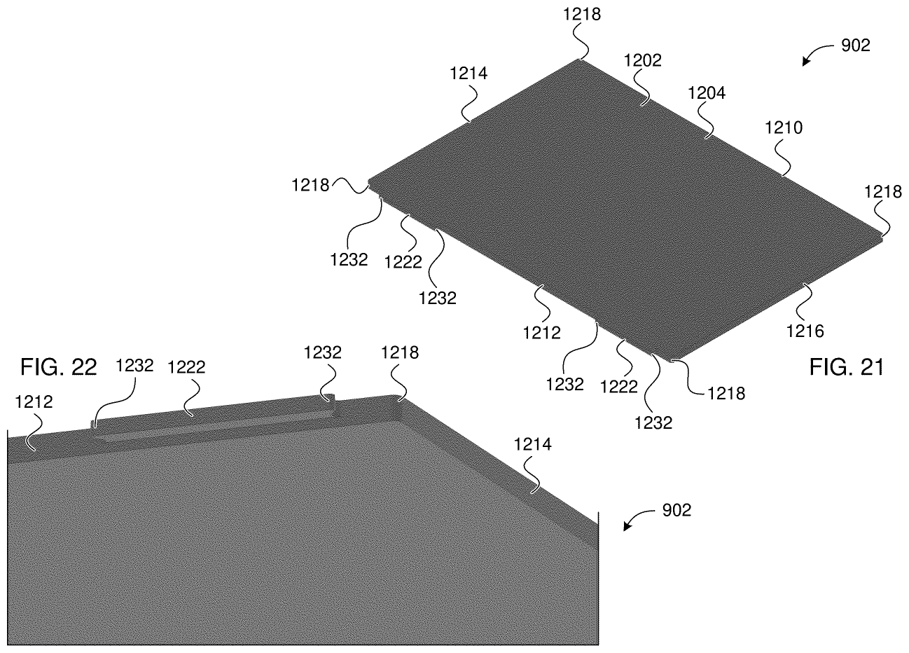

FIGS. 21 and 22 illustrates, in greater detail, the second platform 904 of FIG. 18. The second platform 904 includes a second substantially planar body 1202 having a second support surface 1204, first and second opposed side edges 1210, 1212; first and second opposed end edges 1214, 1216; and four corners 1218. Each of the four corners 1218 being disposed between one side edge 1210, 1212 and one end edge 1214, 1216.

As shown in FIG. 21, the second platform 104 includes a shoulder 1222 disposed along at least a portion of the second side edge 1212. The shoulder 1222 is configured to engage the shelf (e.g., the shelf 1032). In the present example, the shoulder 1222 may be approximately half the thickness of the second substantially planar body 1202. In some examples, the thickness of the shelf 1032 and the shoulder 1222 is equal to the thickness of the first and second platforms 102, 104. Additionally, the first and second platforms 102, 104 are configured to be substantially coplanar when the shoulder 1222 engages the shelf 1032.

In the present example, the shoulder 1222 includes a pair of bumpers 1232 disposed on opposing ends of the shoulder 1222 and configured to engage the shelf 1032 to inhibit relative movement of the first and second platforms 102, 104 along the lengthwise direction 1052. For example, the bumpers 1232 engage the bumpers 1036 of the first platform 102 to limit lengthwise movement of the first and second platforms 102, 104.

In some examples, the second platform 904 does not include a slot. For example, the second platform 104 is not configured to be supported by any vertical legs (e.g., vertical legs 124). The second platform 104 engages the first and third platforms 102, 106 and does not need to be supported by any other support structure.

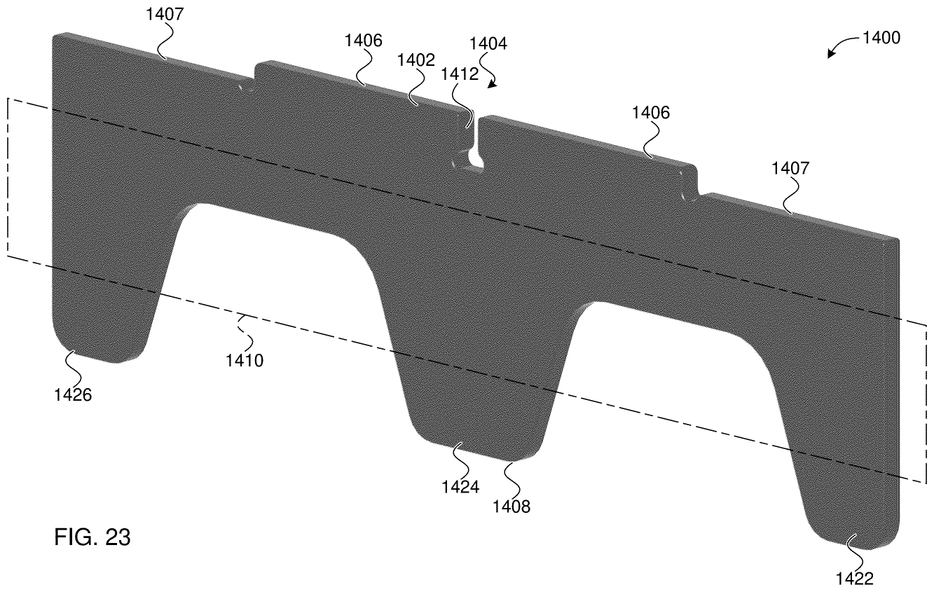

FIG. 23 illustrates a vertical leg 1400. The leg 1400 can be one of the vertical legs 924 of FIG. 18. As shown in FIG. 23, the vertical leg 1400 includes a first tab 1402 and a first notch 1404 disposed on the first tab 1402. The first tab 1402 is configured to be selectively disposed within a slot (e.g., slot 922) of the first platform 902. The notch 1404 functionally engages the slot 922 and the connector 800 in a substantially identical manner as the notch 704 of the leg 700.

The leg 1400 includes a first top surface 1406 disposed on the first tab 1402, a second top surface 1407, and a bottom surface 1408 disposed opposite the first and second top surfaces 1406, 1407. The first top surface 1406 is configured to be aligned and substantially coplanar with the first support surfaces 1004 when disposed in a corresponding slot 922 of the first platforms 902. Additionally, the second top surface 1406 are configured to engage an underside of the first platforms 902 when the first tab 1402 is disposed in the slot 922. Further, the bottom surface 1408 is configured to engage a flat surface of a truck bed. In some examples, truck beds include a crenellated surface and the legs 924 are sized to engage the higher or lower levels of the truck bed to ensure the adjustable modular support assembly 900 is substantially level when assembled and placed in a truck bed.

In the present example, the leg 1400 includes a first leg 1422, a second leg 1424, and a third leg 1426 defining the bottom surface 1408. In the present example, each of the first, second, and third legs 1422, 1424, 1426 engages the ground or a truck bed. As shown in FIG. 23, the first, second, and third legs 1422, 1424, 1426 define an elongated M-shaped sheet. In various examples, the shape of the leg 1400 could be different than shown. For example, the leg 1400 could include two or more of the leg 700 aligned.

The leg 1400 defines a plane 1410 disposed substantially parallel with at least a portion of at least one of the first and second side edges 1010, 1012 of the first platform 102. Similarly, the plane 1410 is also substantially parallel with at least a portion of the first and second side edges 1210, 1212 of the second platform 104, the first and second side edges 510, 512 of the third platform 106, and the first and second side edges 610, 612 of the fourth platform 108.

The adjustable modular support assemblies 100, 900 of the present disclosure provide many benefits over other truck bed storage systems. The adjustable modular support assemblies 100, 900 provide quick and convenient modification of a truck bed for additional storage and convenient use of the truck bed.

First, the adjustable modular support assemblies 100, 900 are manufacturable from sheets of material (e.g., sheet metal, plywood). As a result, the adjustable modular support assemblies 100, 900 can utilize well known computer numerical control (CNC) manufacturing techniques and the many material saving and recycling techniques associated with such manufacturing techniques.

Second, the adjustable modular support assemblies 100, 900 are quickly and easily assembled. The connector 800 is easily installed in the slots 122, 922 of the adjustable modular support assemblies 100, 900. Further, the leg 700, 1400 is easily slid into slots 122, 922 to engage the connector 800. Additionally, when the connector 800 engages the legs 700, 1400, the connectors 800 and legs 700, 1400 are restricted from rotating relative to the corresponding first, third, or fourth platform 102, 106, 108, 902. The simplicity of the connection between the first, third, or fourth platforms 102, 106, 108, 902, the connector 800, and the leg 700, 1400 is an improvement over other assembling techniques and structures.

Example 1. an apparatus, comprising: a pair of support boards, each support board comprising a rectangular slot; a plurality of connectors, each connector, comprising: a T-shaped end comprising a horizontal portion and a vertical portion; and a connector base comprising a pair of connector legs between which a slot is defined, wherein the vertical portion is positioned between the connector base and the horizontal portion and wherein a space is defined between the connector base and the horizontal portion on either side of the vertical portion; a plurality of legs, wherein the horizontal portion of each of the connectors is to be received in one of the rectangular slots and rotated about 90° to couple the connector to the support board and position an adjacent portion of the support board within the space defined by the corresponding connector, wherein each of the legs is to be received in the slot of one of the connector bases to secure the leg relative to the support board, and wherein the support boards are to abut one another when installed in a vehicle to form a platform.

Example 2. The apparatus of example 1, wherein each of the support boards comprise a top surface and wherein each of the connectors comprises a connector top surface that is substantially flush with the top surface of the support board.

Example 3. The apparatus of example 1, wherein each leg comprises a pair of tongues, wherein the pair of tongues for each of the legs is to be received in a corresponding rectangular slot of the support board.

Example 4. The apparatus of example 3, wherein each connector is positioned between a pair of tongues when the connector is coupled to the support board and the leg is secured relative to the support board.

Example 5. The apparatus of example 1, where at least one of the support boards defines a cutout to receive a vehicle tailgate bulkhead.

Example 6. The apparatus of example 1, wherein the support boards form an abutment joint when installed in the vehicle to form the platform.

Example 7. The apparatus of example 6, wherein the support boards comprise a first support board and a second support board, the first support board comprising an end comprising a protrusion and the second support board comprising an end comprising a cutout that receives the protrusion to form the abutment joint.

Example 8. The apparatus of example 1, wherein each support board comprises a longitudinal edge comprising a step-shaped cutout.

Example 9. The apparatus of example 8, wherein the step-shaped cutout comprises a rabbit.

Example 10. The apparatus of example 1, wherein each support board comprises a longitudinal edge comprising a first step-shaped cutout and a second step-shaped cutout, the rectangular slot positioned between the first step-shaped cutout and the second step-shaped cutout.

Example 11. The apparatus of example 10, wherein the each of the first step-shaped cutout and the second step-shaped cutout are keyed step-shaped cutouts.

Example 12. The apparatus of example 1, wherein at least one of the support boards comprise a hand hole.

Example 13. The apparatus of example 1, wherein each of the support boards comprising a first clearance slot on a first side of each of the rectangular slots and a second clearance slot on a second side of the rectangular slot, and wherein the horizontal portion of each of the connectors is received in a corresponding first clearance slot and a corresponding second clearance slot when the corresponding connector is rotated about 90° to position the adjacent portion of the platform within the space defined by the corresponding connector.

Example 14. The apparatus of example 13, wherein the first clearance slot and the second clearance slot of each of the rectangular slots are positioned at a 180-degree of rotation relative to each other.

Example 15. The apparatus of example 1, wherein the connector base comprises top surfaces that extend outwardly from the vertical portion of the T-shaped end and side surfaces, each side surface inwardly taper from one of the top surfaces of the connector base toward an entrance of the slot of the connector base.

Example 16. The apparatus of example 1, wherein the connector base comprises a central protrusion that extends into the slot of the connector base.

Example 17. The apparatus of example 16, wherein the central protrusion is to locate the connector relative to the leg when the leg is received in the slot of the connector base to secure the leg relative to the support board.

Example 18. The apparatus of example 17, wherein each leg comprises a receptacle to receive the central protrusion.

Example 19. The apparatus of example 1, wherein the each leg comprises a plurality legs.

Example 20. The apparatus of example 19, wherein the plurality of legs form an M-shape.

Example 21. An apparatus, comprising: a support board comprising a plurality of rectangular slots; a plurality of connectors, each connector, comprising: a T-shaped end comprising a horizontal portion and a vertical portion; and a connector base comprising a pair of connector legs between which a slot is defined, wherein the vertical portion is positioned between the connector base and the horizontal portion and wherein a space is defined between the connector base and the horizontal portion on either side of the vertical portion; a plurality of legs, wherein the horizontal portion of each of the connectors is to be received in one of the rectangular slots and rotated about 90° to couple the connector to the support board and position an adjacent portion of the support board within the space defined by the corresponding connector, wherein each of the legs is to be received in the slot of one of the connector bases to secure the leg relative to the support board.

Example 22. The apparatus of example 21, wherein the support board comprises a longitudinal edge comprising a step-shaped cutout.

Example 23. The apparatus of example 22, wherein the step-shaped cutout comprises a rabbit.

Example 24. The apparatus of example 23, wherein the support board comprises a longitudinal edge comprising a first step-shaped cutout and a second step-shaped cutout, the support board comprising a spacer positioned between the first step-shaped cutout and the second step-shaped cutout.

Example 25. The apparatus of example 21, further comprising: a second support board comprising a plurality of rectangular slots; a plurality of connectors, each connector, comprising: a T-shaped end comprising a horizontal portion and a vertical portion; and a connector base comprising a pair of connector legs between which a slot is defined, wherein the vertical portion is positioned between the connector base and the horizontal portion and wherein a space is defined between the connector base and the horizontal portion on either side of the vertical portion; a plurality of legs, wherein the horizontal portion of each of the connectors is to be received in one of the rectangular slots and rotated about 90° to couple the connector to the support board and position an adjacent portion of the second support board within the space defined by the corresponding connector, wherein each of the legs is to be received in the slot of one of the connector bases of the connectors to secure the leg relative to the second support board.

Example 26. The apparatus of example 25, wherein the second support board comprises a longitudinal edge comprising a first step-shaped cutout and a second step-shaped cutout, the second support board comprising a spacer positioned between the first step-shaped cutout and the second step-shaped cutout.

Example 27. The apparatus of example 25, further comprising a central support to be positioned between the support board and the second support board, wherein a first lap joint is formed between central support and the support board and a second lap joint is formed between the central support and the second support board.

Example 28. The apparatus of example 27, further comprising a second central support to be positioned between the support board and the second support board, wherein a first lap joint is formed between second central support and the support board and a second lap joint is formed between the second central support and the second support board.

Example 29. An adjustable modular support assembly, comprising: a first platform including: a first substantially planar body having a first support surface, first and second opposed side edges, first and second opposed end edges, and four corners, each of the four corners being disposed between one side edge and one end edge; a slot disposed in the substantially planar body; and a shelf disposed along at least a portion of the first side edge of the first platform; a second platform, including: a second substantially planar body having a second support surface, first and second opposed side edges, first and second opposed end edges, and four corners, each of the four corners being disposed between one side edge and one end edge; and a shoulder disposed along at least a portion of the second side edge of the second platform, wherein the shoulder is configured to engage the shelf, wherein the first and second support surfaces are substantially coplanar; a vertical leg, including a first tab and a first notch disposed on the first tab, the first tab being selectively disposed within the slot of the first platform; and a connector, including a second tab selectively disposed within the slot of the first platform and including a second notch that engages the first notch when the vertical leg and the connector are disposed in the slot of the first platform.

Example 30. The adjustable modular support assembly of example 29, wherein the slot includes a twist-lock slot.

Example 31. The adjustable modular support assembly of example 30, wherein the twist-lock slot includes a first slot disposed substantially parallel with at least one of the first and second side edges of the first platform and a second slot disposed substantially parallel with at least one of the first and second end edge of the first platform, the second slot at least partially intersecting the first slot.

Example 32. The adjustable modular support assembly of example 31, wherein the twist-lock slot additionally includes a contra-leaf twisting aperture.

Example 33. The adjustable modular support assembly of example 29, wherein the first notch and the second notch comprise complementary forked members.

Example 34. The adjustable modular support assembly of example 33, wherein the first notch is upwardly oriented towards the first platform when the first tab is disposed in the slot and the second notch is downwardly oriented away from the first platform when the second tab is disposed in the slot.

Example 35. The adjustable modular support assembly of example 29, wherein the leg defines a plane disposed substantially parallel with at least a portion of at least one of the first and second side edges.

Example 36. The adjustable modular support assembly of example 29, wherein the second platform does not include a slot.

Example 37. The adjustable modular support assembly of example 29, wherein at least one of the shelf and the shoulder includes a pair of bumpers disposed on opposing ends of the shelf or shoulder and configured to engage the other one of the shelf and the shoulder to inhibit relative movement of the first and second platforms along a lengthwise direction.

Example 38. The adjustable modular support assembly of example 29, further comprising a third platform including a third substantially planar body having a third support surface, first and second opposed side edges, first and second opposed end edges, and four corners, each of the four corners being disposed between one side edge and one end edge, wherein the third support surface is substantially coplanar with the first support surface and the second support surface.

Example 39. The adjustable modular support assembly of example 38, wherein the second platform is disposed between the first and third platforms.

Example 40. The adjustable modular support assembly of Example 38, wherein the third platform includes a slot and a shelf disposed along a lengthwise direction of the third platform; a second vertical leg, including a first tab and a first notch disposed on the first tab of the second vertical leg, the first tab of the second vertical leg being selectively disposed within the slot of the third platform; and a second connector, including a second tab of the second connector selectively disposed within the slot of the third platform and including a second notch of the second connector that engages the first notch of the second vertical leg when the second vertical leg and the second connector are disposed in the slot of the third platform.

Example 41. The adjustable modular support assembly of Example 40, wherein the vertical leg and the second vertical leg are substantially parallel.

Example 42. The adjustable modular support assembly of example 29, wherein at least a portion of the second side edge of the first platform is configured to engage a wall of a truck bed.

Example 43. An adjustable modular support assembly, comprising: a platform including: a first substantially planar body having a first support surface, first and second opposed side edges defining a length, first and second opposed end edges defining a width, and four corners, each of the four corners being disposed between one side edge and one end edge; and a twist-lock slot asymmetrically disposed along the width of the platform; a vertical leg including a first tab and a first notch disposed on the first tab, the first tab being selectively disposed within the slot of the first platform; and a connector, including a second tab selectively disposed within the slot of the first platform and including a second notch that engages the first notch when the vertical leg and the connector are disposed in the slot of the first platform.

Example 44. The adjustable modular support assembly of Example 43, wherein the twist-lock slot includes a first slot disposed in a lengthwise direction and a second slot disposed in a widthwise direction, the second slot at least partially intersecting the first slot.

Example 45. The adjustable modular support assembly of Example 44, wherein the twist-lock slot additionally includes a contra-leaf twisting aperture.

Example 46. The adjustable modular support assembly of Example 43, wherein the first notch and the second notch comprise complementary forked members.

Example 47. The adjustable modular support assembly of Example 46, wherein the first notch is upwardly oriented towards the platform and the second notch is downwardly oriented away from the platform.

Example 48. The adjustable modular support assembly of Example 43, wherein the leg defines a plane oriented in a lengthwise direction of the first platform when the first tab is disposed in the twist-lock slot and the connector defines a plane oriented in a widthwise direction of the first platform when the second tab is disposed in the twist-lock slot.

Example 49. The adjustable modular support assembly of Example 43, wherein at least a portion of the second side edge of the first platform is configured to engage a wall of a truck bed.

Example 50. An adjustable modular support assembly, comprising: a pair of platforms spaced apart from each other, each platform comprising: a substantially planar body having a support surface, first and second opposed side edges and first and second opposed end edges; and a slot disposed in the substantially planar body; a plurality of legs, each leg including a first tab and a first notch disposed on the first tab, the first tab being selectively disposed within a corresponding slot of the pair of platforms; and a plurality of connectors, each connector including a second tab selectively disposed within a corresponding slot of the pair of platforms and including a second notch that engages the first notch when one of the plurality of legs and one of the plurality of connectors is disposed in the slot of the first platform.

Example 51. The adjustable modular support assembly of Example 50, further comprising a footer platform, including a support surface, first and second opposed side edges and first and second opposed end edges, and a shoulder disposed on the first side edge of the footer platform; wherein each of the pair of platforms include a shelf, disposed on the second end edge of each of the pair of platforms and the shelf configured to engage the shoulder of the footer platform.

Example 52. The adjustable modular support assembly of Example 51, the footer platform further comprising a slot and at least one leg and at least one connector on the footer.

Example 53. The adjustable modular support assembly of Example 51, wherein at least one of the shelf and the shoulder includes a pair of bumpers disposed on opposing ends of the shelf or shoulder and configured to engage the other one of the shelf and the shoulder to inhibit relative movement of the first and second platforms along a lengthwise direction.

Example 54. The adjustable modular support assembly of Example 50, further comprising a middle platform, disposed between the pair of platforms, the middle platform including: a support surface, first and second opposed side edges and first and second opposed end edges, and a shoulder disposed on the first side edge of the middle platform; wherein at least one of the pair of platforms includes a shelf disposed on the first side edge configured to engage the shoulder of the middle platform.

Example 54. The adjustable modular support assembly of Example 54, wherein the middle platform does not include a slot.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An apparatus, comprising:
a pair of support boards, each support board comprising a rectangular slot;
a plurality of connectors, each connector, comprising:
a T-shaped end comprising a horizontal portion and a vertical portion; and
a connector base comprising a pair of connector legs between which a slot is defined, wherein the vertical portion is positioned between the connector base and the horizontal portion and wherein a space is defined between the connector base and the horizontal portion on either side of the vertical portion;
a plurality of legs,
wherein the horizontal portion of each of the connectors is to be received in one of the rectangular slots and rotated about 90° to couple the connector to the support board and position an adjacent portion of the support board within the space defined by the corresponding connector,
wherein each of the legs is to be received in the slot of one of the connector bases to secure the leg relative to the support board, and
wherein the support boards are to abut one another when installed in a vehicle to form a platform.

2. The apparatus of claim 1, wherein each of the support boards comprise a top surface and wherein each of the connectors comprises a connector top surface that is substantially flush with the top surface of the support board.

3. The apparatus of claim 1, wherein each leg comprises a pair of tongues, wherein the pair of tongues for each of the legs is to be received in a corresponding rectangular slot of the support board.

4. The apparatus of claim 3, wherein each connector is positioned between a pair of tongues when the connector is coupled to the support board and the leg is secured relative to the support board.

5. The apparatus of claim 1, where at least one of the support boards defines a cutout to receive a vehicle tailgate bulkhead.

6. The apparatus of claim 1, wherein the support boards form an abutment joint when installed in the vehicle to form the platform.

7. The apparatus of claim 6, wherein the support boards comprise a first support board and a second support board, the first support board comprising an end comprising a protrusion and the second support board comprising an end comprising a cutout that receives the protrusion to form the abutment joint.

8. The apparatus of claim 1, wherein each support board comprises a longitudinal edge comprising a step-shaped cutout.

9. The apparatus of claim 8, wherein the step-shaped cutout comprises a rabbit.

10. The apparatus of claim 1, wherein each support board comprises a longitudinal edge comprising a first step-shaped cutout and a second step-shaped cutout, the rectangular slot positioned between the first step-shaped cutout and the second step-shaped cutout.

11. The apparatus of claim 10, wherein the each of the first step-shaped cutout and the second step-shaped cutout are keyed step-shaped cutouts.

12. The apparatus of claim 1, wherein at least one of the support boards comprise a hand hole.

13. The apparatus of claim 1, wherein each of the support boards comprising a first clearance slot on a first side of each of the rectangular slots and a second clearance slot on a second side of the rectangular slot, and wherein the horizontal portion of each of the connectors is received in a corresponding first clearance slot and a corresponding second clearance slot when the corresponding connector is rotated about 90° to position the adjacent portion of the platform within the space defined by the corresponding connector.

14. The apparatus of claim 13, wherein the first clearance slot and the second clearance slot of each of the rectangular slots are positioned at a 180-degree of rotation relative to each other.

15. The apparatus of claim 1, wherein the connector base comprises top surfaces that extend outwardly from the vertical portion of the T-shaped end and side surfaces, each side surface inwardly taper from one of the top surfaces of the connector base toward an entrance of the slot of the connector base.

16. The apparatus of claim 1, wherein the connector base comprises a central protrusion that extends into the slot of the connector base.

17. The apparatus of claim 16, wherein the central protrusion is to locate the connector relative to the leg when the leg is received in the slot of the connector base to secure the leg relative to the support board.

18. The apparatus of claim 17, wherein each leg comprises a receptacle to receive the central protrusion.

19. The apparatus of claim 1, wherein each leg comprises a plurality legs.

20. The apparatus of claim 19, wherein the plurality of legs form an M-shape.

21. An apparatus, comprising:
a support board comprising a plurality of rectangular slots;
a plurality of connectors, each connector, comprising:
a T-shaped end comprising a horizontal portion and a vertical portion;
a connector base comprising a pair of connector legs between which a slot is defined, wherein the vertical portion is positioned between the connector base and the horizontal portion and wherein a space is defined between the connector base and the horizontal portion on either side of the vertical portion; and
a plurality of legs,
wherein the horizontal portion of each of the connectors is to be received in one of the rectangular slots and rotated about 90° to couple the connector to the support board and position an adjacent portion of the support board within the space defined by the corresponding connector,
wherein each of the legs is to be received in the slot of one of the connector bases to secure the leg relative to the support board.

22. The apparatus of claim 21, wherein the support board comprises a longitudinal edge comprising a step-shaped cutout.

23. The apparatus of claim 22, wherein the step-shaped cutout comprises a rabbit.

24. The apparatus of claim 23, wherein the support board comprises a longitudinal edge comprising a first step-shaped cutout and a second step-shaped cutout, the support board comprising a spacer positioned between the first step-shaped cutout and the second step-shaped cutout.

25. The apparatus of claim 21, further comprising:
a second support board comprising a plurality of rectangular slots;
a plurality of connectors, each connector, comprising:
a T-shaped end comprising a horizontal portion and a vertical portion; and
a connector base comprising a pair of legs between which a slot is defined, wherein the vertical portion is positioned between the connector base and the horizontal portion and wherein a space is defined between the connector base and the horizontal portion on either side of the vertical portion;
a plurality of legs,
wherein the horizontal portion of each of the connectors is to be received in one of the rectangular slots and rotated about 90° to couple the connector to the support board and position an adjacent portion of the second support board within the space defined by the corresponding connector,
wherein each of the legs is to be received in the slot of one of the connector bases of the connectors to secure the leg relative to the second support board.

26. The apparatus of claim 25, wherein the second support board comprises a longitudinal edge comprising a first step-shaped cutout and a second step-shaped cutout, the second support board comprising a spacer positioned between the first step-shaped cutout and the second step-shaped cutout.

27. The apparatus of claim 25, further comprising a central support to be positioned between the support board and the second support board, wherein a first lap joint is formed between central support and the support board and a second lap joint is formed between the central support and the second support board.

28. The apparatus of claim 27, further comprising a second central support to be positioned between the support board and the second support board, wherein a first lap joint is formed between second central support and the support board and a second lap joint is formed between the second central support and the second support board.
